(19) United States
(12) Patent Application Publication
(10) Pub. No.: US 2026/0195126 A1
(43) Pub. Date: Jul. 9, 2026

(54) SHARED MEMORY ACCESS METHOD AND DEVICE, COMPUTER EQUIPMENT, STORAGE MEDIUM, AND PROGRAM PRODUCT

(71) Applicant: Glenfly Tech Co., Ltd., Shanghai (CN)

(72) Inventors: Zhongyu TAO, Shanghai (CN); Huaisheng ZHANG, Shanghai (CN); Yaohui ZENG, Shanghai (CN)

(21) Appl. No.: 19/169,440

(22) Filed: Apr. 3, 2025

(30) Foreign Application Priority Data
Jan. 7, 2025 (CN) 202510025176.0

(51) Int. Cl. G06F 9/30; G06F 9/38

(52) U.S. Cl. CPC G06F 9/3001; G06F 9/30029; G06F 9/3858

(57) ABSTRACT

Disclosed are an SM access method and device, a computer equipment, and a non-transitory computer-readable storage medium. The method includes: receiving an SM reduction instruction; performing an equal-reduction judgment on valid lanes according to address information in the SM reduction instruction, and splitting the valid lanes according to a result of the equal-reduction judgment; reading data from the SM according to split results of the valid lanes, the split result being associated with the number of times the data need to be read from the SM; performing a reduction operation according to the data read from the SM, the source data and the operation code in the SM reduction instruction, and writing a result of the reduction operation into the SM.

### CROSS-REFERENCE TO RELATED APPLICATIONS

The present application claims the priority to Chinese patent application No. 202510025176.0, filed on Jan. 7, 2025, entitled “SHARED MEMORY ACCESS METHOD AND DEVICE, EQUIPMENT, STORAGE MEDIUM, AND PROGRAM PRODUCT”, which is incorporated herein by reference in its entirety.

### TECHNICAL FIELD

The present application relates to the field of computer technology, and in particular to a Shared Memory (SM) access method and device, a computer equipment, a computer-readable storage medium and a computer program product.

### BACKGROUND

With the rapid development of computer technology, a large number of parallel processing units involved in a Graphic Processing Unit (GPU) may perform parallel computing of single instruction multiple data (SIMD) streams through programing, for example, a General-Purpose Graphic Processing Unit (GPGPU) performs parallel computing.

In the conventional technology, in parallel computing performed by a GPGPU, work items in the same workgroup may access the same SM space and perform reduction operations or atomic operations. Where the reduction operations need to be performed in sequence, and the address of each lane in a workgroup wave (a group of wave blocks that may be executed in parallel) must first be read from the SM, then a reduction operation is performed, and finally the result is written into the SM through the SM write operation.

### SUMMARY

In a first aspect, the present application provides a shared memory (SM) access method including: receiving an SM reduction instruction, instruction information in the SM reduction instruction including address information, an operation code, and source data; performing an equal-reduction judgment on valid lanes according to address information in the SM reduction instruction, and splitting the valid lanes according to a result of the equal-reduction judgment, the address information being configured to indicate addresses of the valid lanes; reading data from the SM according to split results of the valid lanes, the split result being associated with the number of times the data need to be read from the SM; and performing a reduction operation according to the data read from the SM, the source data and the operation code in the SM reduction instruction, and writing a result of the reduction operation into the SM.

In an embodiment, receiving the SM reduction instruction includes: receiving the SM reduction instruction sent by an arithmetic logic unit (ALU); and storing the instruction information in the SM reduction instruction in an SM buffer.

In an embodiment, performing the equal-reduction judgment on the valid lanes according to the address information in the SM reduction instruction, and splitting the valid lanes according to the result of the equal-reduction judgment, include: obtaining the instruction information from the SM buffer through a reduction instruction information control unit; traversing and obtaining the addresses of the valid lanes, and performing an XOR operation on addresses of each two valid lanes; if a result of an XOR operation of two valid lanes is not 0, judging that the addresses of the two valid lanes are different; and if the result of the XOR operation of the two valid lanes is 0, judging that the addresses of the two valid lanes are the same; merging valid lanes with the same address, and retaining valid lanes with different addresses; and splitting the valid lanes according to the lane addresses corresponding to the valid lanes with different addresses.

In an embodiment, traversing and obtaining the addresses of the valid lanes, and performing the XOR operation on the addresses of each two valid lanes, include: performing the XOR operation on an address of an i-th valid lane and an address of an (i+1)-th valid lane. A value of i is a natural number in a range [0, K−1], and K denotes a total number of the valid lanes.

In an embodiment, traversing and obtaining the addresses of the valid lanes, and performing the XOR operation on the addresses of each two valid lanes, further include: when a result of the XOR operation of the address of the i-th valid lane and the address of the (i+1)-th valid lane is 0, outputting a result False; when the result of the XOR operation of the address of the i-th valid lane and the address of the (i+1)-th valid lane is not 0, judging whether i+1 is equal to K; if so, outputting a result True, and if not, increasing i by 1, and re-judging whether the result of the XOR operation of the address of the i-th valid lane and the address of the (i+1)-th valid lane is 0, until equal-reduction judgments for the valid lanes are all completed.

In an embodiment, splitting the valid lanes according to the lane addresses corresponding to the valid lanes with different addresses includes: if the addresses of the valid lanes are the same, determining the number of splits to be 1, and storing the addresses of the valid lanes in one storage bank; and if an address of a valid lane is different, judging whether the addresses of the valid lanes span different storage banks; if the addresses of the valid lanes are stored in one storage bank, storing the addresses of the valid lanes in the storage bank; and if the addresses of the valid lanes are not all stored in one storage bank, determining the number of splits according to the number of storage banks spanned by the addresses of the valid lanes. A configuration of the SM determines the number of storage banks and a width of each storage bank; each storage bank corresponds to one split unit, and the number of split units corresponds to the number of times the data need to be read from the SM.

In an embodiment, reading the data from the SM according to the split results of the valid lanes includes: determining the number of times the data need to be read from the SM based on the split results of the valid lanes, and determining an address in an SM read request corresponding to each read operation; and reading the data from the SM based on the address in the SM read request.

In an embodiment, performing the reduction operation according to the data read from the SM, the source data and the operation code in the SM reduction instruction includes: matching the data read from the SM to valid lanes indicated by each lane index to obtain data corresponding to each valid lane; and performing the reduction operation on the data corresponding to each valid lane and the source data corresponding to each valid lane in the SM reduction instruction, according to the operation code in the SM reduction instruction.

In an embodiment, the instruction information in the SM reduction instruction further includes the number of the valid lanes, an identification information on whether to write the result of the reduction operation, and a data format supported by the reduction.

In an embodiment, after writing the result of the reduction operation into the SM, the method further includes: when the identification information on whether to write the result of the reduction operation is not NULL, writing the result of the reduction operation into a general register file (GRF).

In an embodiment, the data format supported by the reduction is 32 bits or 64 bits.

In an embodiment, the operation code is an addition operation, a minimum operation, or a maximum operation.

In a second aspect, the present application provides a shared memory (SM) access device, including a receiving circuit, a judging circuit, a reading circuit, and a reduction circuit.

The receiving circuit is configured to receive an SM reduction instruction. Instruction information in the SM reduction instruction includes address information, an operation code, and source data.

The judging circuit is configured to perform an equal-reduction judgment on valid lanes according to address information in the SM reduction instruction and split the valid lanes according to a result of the equal-reduction judgment. The address information is configured to indicate addresses of the valid lanes.

The reading circuit is configured to read data from the SM according to split results of the valid lanes. The split result is associated with the number of times the data need to be read from the SM.

The reduction circuit is configured to perform a reduction operation according to the data read from the SM, the source data and the operation code in the SM reduction instruction and write a result of the reduction operation into the SM.

In a third aspect, the present application provides a computer equipment, including a memory and a processor. The memory has a computer program stored thereon, and the processor, when executing the computer program, implements steps of: receiving an SM reduction instruction, instruction information in the SM reduction instruction including address information, an operation code, and source data; performing an equal-reduction judgment on valid lanes according to address information in the SM reduction instruction, and splitting the valid lanes according to a result of the equal-reduction judgment, the address information being configured to indicate addresses of the valid lanes; reading data from the SM according to split results of the valid lanes, the split result being associated with the number of times the data need to be read from the SM; and performing a reduction operation according to the data read from the SM, the source data and the operation code in the SM reduction instruction, and writing a result of the reduction operation into the SM.

In a fourth aspect, the present application provides a computer-readable storage medium, having a computer program stored thereon. The computer program, when executed by a processor, causes the processor to implement steps of: receiving an SM reduction instruction, instruction information in the SM reduction instruction including address information, an operation code, and source data; performing an equal-reduction judgment on valid lanes according to address information in the SM reduction instruction, and splitting the valid lanes according to a result of the equal-reduction judgment, the address information being configured to indicate addresses of the valid lanes; reading data from the SM according to split results of the valid lanes, the split result being associated with the number of times the data need to be read from the SM; and performing a reduction operation according to the data read from the SM, the source data and the operation code in the SM reduction instruction, and writing a result of the reduction operation into the SM.

In a fifth aspect, the present application provides a computer program product, including a computer program. The computer program, when executed by a processor, implements steps of: receiving an SM reduction instruction, instruction information in the SM reduction instruction including address information, an operation code, and source data; performing an equal-reduction judgment on valid lanes according to address information in the SM reduction instruction, and splitting the valid lanes according to a result of the equal-reduction judgment, the address information being configured to indicate addresses of the valid lanes; reading data from the SM according to split results of the valid lanes, the split result being associated with the number of times the data need to be read from the SM; and performing a reduction operation according to the data read from the SM, the source data and the operation code in the SM reduction instruction, and writing a result of the reduction operation into the SM.

In the above-mentioned SM access method and device, the computer equipment, the computer-readable storage medium and the computer program product, the SM reduction instruction is received, and the instruction information included in the SM reduction instruction includes the address information, the operation code and the source data, thus the SM can be accessed according to the SM reduction instruction to implement the reduction operation. According to the address information included in the SM reduction instruction, the equal-reduction judgment is performed on the valid lanes, and the valid lanes are split according to the result of the equal-reduction judgment. The address information is configured to indicate the addresses of the valid lanes, thus the valid lanes with the same address can be merged, and the valid lanes with the same address are not read repeatedly. According to the split results of the valid lanes, the data are read from the SM. The split result is associated with the number of times data need to be read from the SM, thereby reducing the number of times the SM is read. The reduction operation is performed according to the data read from the SM, the source data and the operation code included in the SM reduction instruction, and the result of the reduction operation is written into the SM, so that the valid lanes with the same address are automatically merged, thereby reducing the number of times the SM is read and written without providing additional hardware logic, and significantly improving the efficiency of the SM data reduction. The method may be applied to SMs with different configurations, may be applied to different reduction operation codes, and supports different data formats.

### BRIEF DESCRIPTION OF THE DRAWINGS

In order to illustrate the technical solutions of the embodiments of the present disclosure more clearly, the drawings needed for the description of the embodiments are briefly described hereinafter. Obviously, the drawings described hereinafter are only some embodiments of the present disclosure. For the ordinary skilled in the art, other drawings may be obtained based on these drawings without creative work.

FIG. 1 is an application environment view of a shared memory (SM) access method according to an embodiment of the present application;

FIG. 2 is a schematic view of an SM according to an embodiment of the present application;

FIG. 3 is a schematic view showing a workgroup according to an embodiment of the present application;

FIG. 4 shows a schematic flowchart of an SM access method according to an embodiment of the present application;

FIG. 5 is a schematic view showing an architecture of an SM reduction operation according to an embodiment of the present application;

FIG. 6 (a) is a flowchart of performing an equal-reduction judgment according to an embodiment of the present application;

FIG. 6 (b) is a flowchart of performing an equal-reduction judgment according to another embodiment of the present application;

FIG. 7 is a schematic flowchart of an SM access method according to another embodiment of the present application;

FIG. 8 (a) is a schematic view showing information related to a reduction operation according to an embodiment of the present application;

FIG. 8 (b) is a schematic view showing information related to another reduction operation according to an embodiment of the present application;

FIG. 9 is a schematic view showing a principle of splitting an effective channel according to an embodiment of the present application;

FIG. 10 is a schematic flowchart of an SM access method according to yet another embodiment of the present application;

FIG. 11 is a block diagram showing an SM access device according to an embodiment of the present application;

FIG. 12 is a view showing an internal structure of a computer equipment according to an embodiment of the present application.

### DETAILED DESCRIPTION OF THE EMBODIMENTS

In order to make the purpose, technical solutions and advantages of the present application clearer and better understood, the present application is further described in detail hereinafter in conjunction with the accompanying drawings and embodiments. It should be understood that the specific embodiments described herein are only used to explain the present application but not intended to limit the present application.

Before introducing a shared memory (SM) access method provided by the present application in detail, the following explanations are given for computer terms used in the specification and claims of the present invention.
1) Arithmetic logic unit (ALU), configured to send a read and/or write request for SM and lane information to a shared memory controller (SMC), for example, send the address and/or data of a work item to the SMC.
2) General register file (GRF), configured to store source data required by the ALU, such as data returned by read operations and received from the SMC for ALU operations.
3) SMC, configured to process the read and/or write requests and lane information sent by the ALU, and including a lane-address-continuity detecting unit and a split requesting unit, and configured to control the read operation and/or write operation for the SM and bypass the data returned by the read request to the general register file. The lane-address-continuity detecting unit further includes a processing mode selecting unit.
4) SM, configured store the lane data of work items. The SM may be configured according to the number m of storage banks, the byte index n of the storage bank width, and the number k of buffer lines.

In the related art, for the reduction instruction for the lanes with the same address in the workgroup wave, multiple read and write operations are required, thus resulting in a decrease in the performance of the SM reduction operation.

Based on this, in view of the above technical problem, it is necessary to provide an SM access method and device, a computer equipment, a computer-readable storage medium and a computer program product that can reduce the number of read and write times in the SM reduction operation and improve the performance of the SM reduction operation.

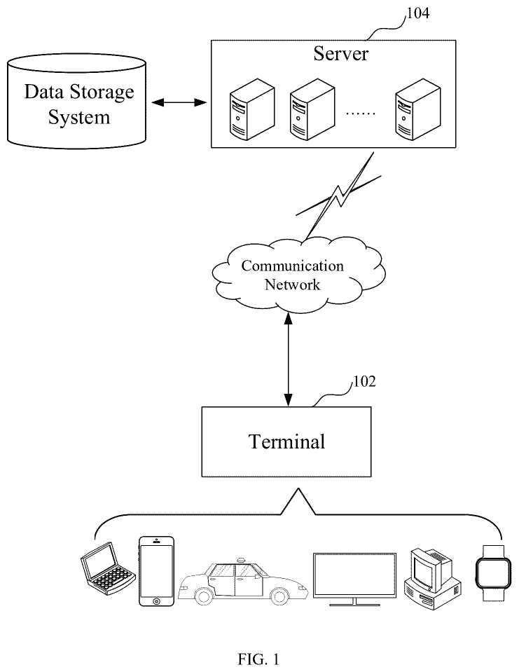

An SM access method provided by the embodiments of the present application may be applied to an application environment shown in FIG. 1. A terminal 102 communicates with a server 104 through the network. A data storage system can store the data need to be processed by the server 104. The data storage system may be integrated on the server 104, or may be placed on the cloud or other network servers. The terminal 102 may be, but is not limited to, various personal computers, laptops, smart phones, tablet computers, Internet of Things devices, or portable wearable devices. The Internet of Things devices may be smart speakers, smart TVs, smart air conditioners, smart car devices, or projection devices, etc. The portable wearable devices may be smart watches, smart bracelets, or head-mounted devices, etc. The head-mounted device may be a virtual reality (VR) device, an augmented reality (AR) device, or smart glasses, etc. The server 104 may be an independent physical server, or a server cluster composed of multiple physical servers or a distributed system, or a cloud server that provides cloud computing services.

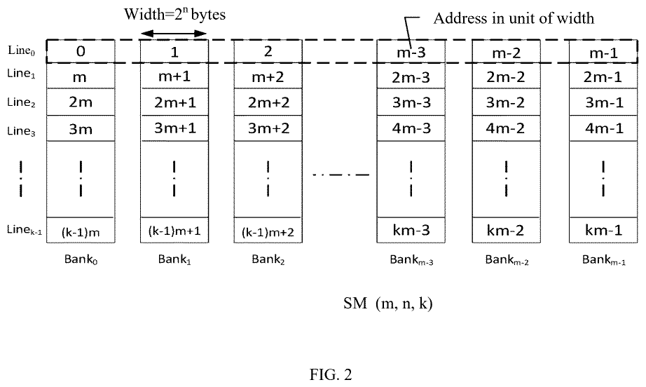

Exemplarily, FIG. 2 is a schematic view of an SM according to an embodiment of the present application. As shown in FIG. 2, the SM includes m storage banks, namely, storage banks Bank₀, Bank₁, Bank₂ . . . Bankₘ₋₃, Bankₘ₋₂, Bankₘ₋₁, where m is an integer greater than 1. Each storage bank includes k buffer lines, namely, buffer lines Line₀, Line₁, Line₂, Line₃ . . . Lineₖ₋₁, where k is also an integer greater than 1. Specifically, the storage width of Line₀ in Bank₀ is 2ⁿ Bytes, where n denotes a byte exponent. Therefore, the size of the entire SM (m, n, k) can be expressed as Bytes.

It can be seen that the SM may be configured according to the number m of the storage banks, the byte index n of the storage bank width, and the number k of the buffer lines. The above parameters m, n, k are configuration information of the SM.

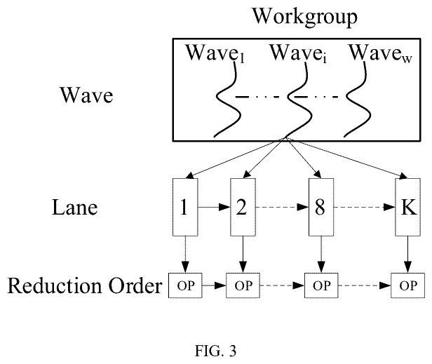

Exemplarily, FIG. 3 is a schematic view showing a workgroup according to an embodiment of the present application. As shown in FIG. 3, a workgroup may construct w waves (Wave₁, Wave₂ . . . Wave_{w}) according to a wave template, and each wave contains N lanes. The same instruction is usually executed in parallel for these N lanes, forming a Single Instruction Multiple Data (SIMD) stream architecture. The order of reduction is starting from the first lane, the reduction operation is performed in sequence and does not end until the N-th lane, and OP represents an operation. Exemplarily, atomic operations may include an atomic Addition (Add), and an atomic Exclusive OR (XOR), etc.

In the prior art, when waves of a workgroup perform reduction operations on data in an SM, the address of each lane in each wave must first be read from the SM, then the reduction operation is performed, and finally the result of the reduction operation is written into the SM through a write operation for the SM. In this way, multiple read and write operations will be performed on lanes with the same address in the wave, resulting in a decrease in the performance of the SM reduction operation.

In view of the above problem, in an embodiment of the present application, the lane addresses of the workgroup waves are detected, and it is determined whether the addresses of valid lanes are exactly the same; when the addresses of the valid lanes are the same, only one read operation and write operation is performed on the corresponding addresses in the SM, thereby reducing the number of read and write operations for the SM during the reduction operation and improving the performance of the SM reduction operation.

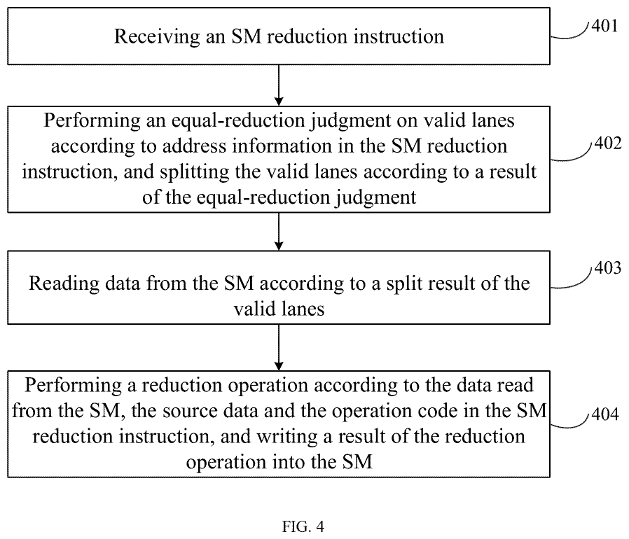

In an exemplary embodiment, as shown in FIG. 4, an SM access method is provided. The method of this embodiment may include the following steps 401 to 404.

In Step 401, an SM reduction instruction is received.

Instruction information included in the SM reduction instruction includes address information, an operation code, and source data.

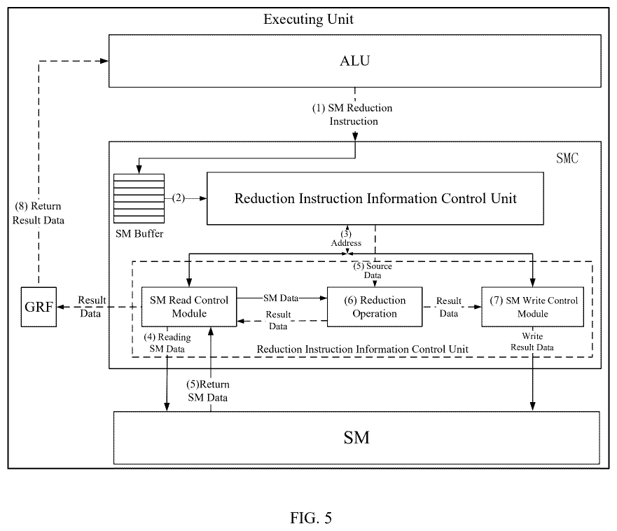

Exemplarily, FIG. 5 is a schematic view showing an architecture of an SM reduction operation according to an embodiment of the present application. As shown in FIG. 5, the ALU sends an SM reduction instruction to the SMC. The instruction information included in the SM reduction instruction includes an operation code, address information, source data, a lane validity mask, etc. Referring to FIG. 5, it can be seen that the instruction information included in the SM reduction instruction sent by the ALU is stored in an SM buffer. Then, the instruction information (such as the address information, the operation code, and the source data) is read from the SM buffer by a reduction instruction information control unit in the SMC. The SMC is further configured to execute instructions for SM, such as executing SM read instructions, SM write instructions, and SM reduction instructions. The SM can be used to store workgroup data, where the parameters m, n, and k of the SM may be configured as needed.

In Step 402, an equal-reduction judgment is performed on valid lanes according to the address information included in the SM reduction instruction, and the valid lanes are split according to the result of the equal-reduction judgment.

The address information is configured to indicate the addresses of the valid lanes.

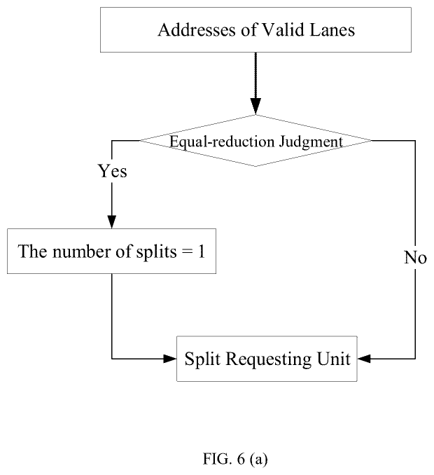

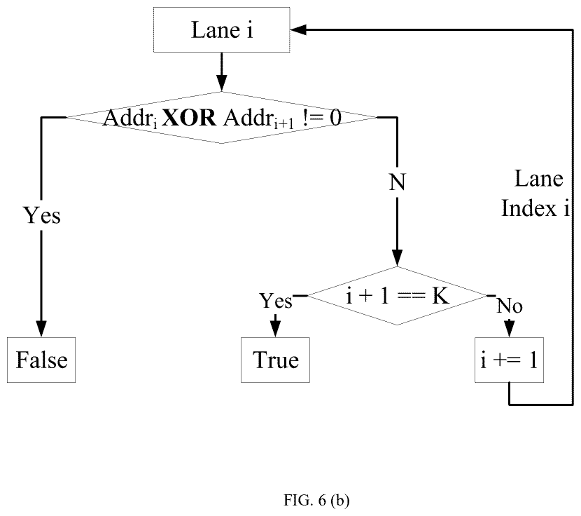

Exemplarily, referring to FIG. 5, it can be seen that the reduction instruction information control unit may perform an equal-reduction judgment on the valid lanes according to the procedures shown in FIG. 6 (a) and FIG. 6 (b) based on the address information included in the SM reduction instruction. FIG. 6 (a) shows the case where the addresses of all valid lanes are the same, and FIG. 6 (b) shows procedures for judging the equal-reduction of valid lanes.

Exemplarily, the equal-reduction judgment refers to: obtaining, by the reduction instruction information control unit, the instruction information from the SM buffer; traversing and obtaining the addresses of the valid lanes, and performing an XOR operation on the addresses of each two valid lanes. If a result of an XOR operation of two valid lanes is not 0, it is judged that the addresses of the two valid lanes are different; if the result of the XOR operation of two valid lanes is 0, it is judged that the addresses of the two valid lanes are the same.

Exemplarily, referring to FIG. 6 (b), an exclusive OR (XOR) operation is performed on the address of the i-th valid lane (Addrᵢ) and the address of the (i+1)-th valid lane (Addrᵢ₊₁), where the value of i is a natural number in a range [0, K−1], and K denotes the total number of the valid lanes. When the result of the XOR operation of the address of the i-th valid lane and the address of the (i+1)-th valid lane is 0, the output result is False. When the result of the XOR operation of the address of the i-th valid lane and the address of the (i+1)-th valid lane is not 0, it is judged whether i+1 is equal to K. If so, the output result is True. If not, i is increased by 1, and it is re-judged whether the result of the exclusive OR operation of the address of the i-th valid lane and the address of the (i+1)-th valid lane is 0, until the equal-reduction judgments for the valid lanes are all completed.

Exemplarily, the valid lanes with the same address are merged, and only valid lanes with different addresses are retained; and the valid lanes are split according to the addresses corresponding to the valid lanes with different addresses.

In one possible case, referring to FIG. 6 (a), if the results of the equal-reduction judgements on the addresses of the valid lanes are all 0, that is, the addresses of the valid lanes are all the same, then the number of splits is determined to be 1, and the addresses of the valid lanes are all stored in one storage bank.

In another possible case, referring to FIG. 6(b), if an address of a valid lane is different, it is judged whether the addresses of the valid lanes span different storage banks. If the addresses of the valid lanes are stored in one storage bank, the addresses of the valid lanes are all stored in this storage bank.

In yet another possible case, as shown in FIG. 6(b), if the addresses of the valid lanes are not all stored in one storage bank, the number of splits is determined according to the number of storage banks spanned by the addresses of the valid lanes.

It should be noted that the configuration of the SM determines the number of storage banks and the width of each storage bank. Each storage bank corresponds to one split unit, and the number of split units corresponds to the number of times data need to be read from the SM.

In Step 403, data are read from the SM according to the split results of the valid lanes.

The split result is associated with the number of times data need to be read from the SM.

In this embodiment, referring to FIG. 5, the reduction instruction information control unit sends an SM read request, and an SM read control module reads data from the SM according to the address in the SM read request.

Exemplarily, the number of times data need to be read from the SM can be determined based on the split results of the valid lanes, and the address in the SM read request corresponding to each read operation can be determined; and the corresponding data can be read from the SM based on the address in the SM read request.

In Step 404, a reduction operation is performed according to the data read from the SM, the source data and the operation code included in the SM reduction instruction, and the result of the reduction operation is written into the SM.

In this embodiment, referring to FIG. 5, the reduction operation is performed based on the data read from the SM and the source data included in the SM reduction instruction. Then, the result of the reduction operation is fed back to an SM write control module, and the SM write control module writes the result of the reduction operation into the SM.

Exemplarily, the data read from the SM are matched to valid lanes indicated by each lane index to obtain data corresponding to each valid lane; and according to the operation code included in the SM reduction instruction, the reduction operation is performed on the data corresponding to each valid lane and the source data corresponding to each valid lane in the SM reduction instruction.

In the SM access method above, the SM reduction instruction is received, and the instruction information included in the SM reduction instruction includes the address information, the operation code and the source data, thus the SM can be accessed according to the SM reduction instruction to implement the reduction operation. According to the address information included in the SM reduction instruction, the equal-reduction judgment is performed on the valid lanes, and the valid lanes are split according to the result of the equal-reduction judgment. The address information is configured to indicate the addresses of the valid lanes, thus the valid lanes with the same address can be merged, and the valid lanes with the same address are not read repeatedly. According to the split results of the valid lanes, the data are read from the SM. The split result is associated with the number of times data need to be read from the SM, thereby reducing the number of times the SM is read. The reduction operation is performed according to the data read from the SM, the source data and the operation code included in the SM reduction instruction, and the result of the reduction operation is written into the SM, so that the valid lanes with the same address are automatically merged, thereby reducing the number of times the SM is read and written without providing additional hardware logic, and significantly improving the efficiency of the SM data reduction. The method may be applied to SMs with different configurations, may be applied to different reduction operation codes, and supports different data formats.

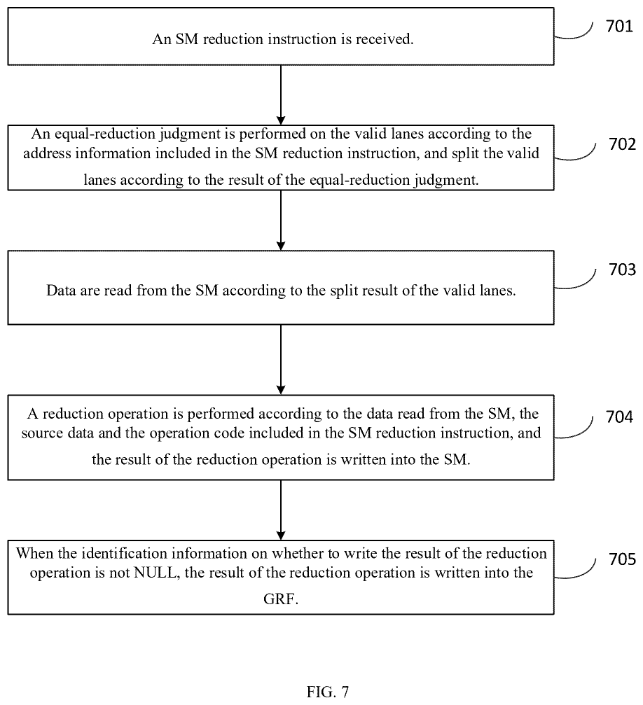

In another exemplary embodiment, as shown in FIG. 7, an SM access method is provided. The method of this embodiment may include steps 701 to 705.

In Step 701, an SM reduction instruction is received.

In Step 702, an equal-reduction judgment is performed on the valid lanes according to the address information included in the SM reduction instruction, and the valid lanes are split according to the result of the equal-reduction judgment.

In Step 703, data are read from the SM according to the split results of the valid lanes.

In Step 704, a reduction operation is performed according to the data read from the SM, the source data and the operation code included in the SM reduction instruction, and the result of the reduction operation is written into the SM.

In this embodiment, for the specific implementation procedures and technical effects of steps 701 to 704, please refer to the relevant descriptions of steps 401 to 404 in the method embodiments shown in FIG. 4, which are not described repeatedly hereinafter.

In Step 705, when the identification information on whether to write the result of the reduction operation is not NULL, the result of the reduction operation is written into the GRF.

In this embodiment, the GRF is configured to store the result returned by the SM reduction instruction operation.

Exemplarily, the instruction information included in the SM reduction instruction further includes the number of the valid lanes, the identification information on whether to write the result of the reduction operation, and the data format supported by the reduction. When the identification information on whether to write the result of the reduction operation is NULL, the result of the reduction operation may not be written into the GRF.

Exemplarily, the SM configuration is (m, n, k)=(16, 2, 1024), that is, the number of banks is 16, the storage width is 2² bytes, and the number of buffer lines is 1024. Based on this, the following SM reduction instruction is generated:
(Pn)SM_REDU Dest, Addr, Src_Data2, Src_Data1, OpCode, data_fmt

Where Pn represents a predictable register file (PRF), which is configured to store the valid lanes of the SM reduction instruction. Dest represents whether the result of the reduction operation need to be written into the GRF or not, and the value of Dest may be NULL, that is, the result of the reduction operation is not written into the GRF. Addr represents the addresses of the valid lanes of the SM reduction instruction. Src_Data1 and Src_Data2 represent the source data of the SM reduction instruction. OpCode represents the operation code of the SM reduction instruction, such as: addition operation, minimum operation, maximum operation, etc. In some other embodiments, the operation code of the SM reduction instruction may also be an operation of AND, OR, XOR, EXCHANGE, UNSIGNED MIN, UNSIGNED MAX, or COMPARE EXCHANGE. data_fmt represents the data format supported by the reduction operation, such as 32 bits, or 64 bits, etc.

Exemplarily, there are two SM reduction instructions as follows:
(P1)SM_REDU NULL, R10, VOID, R16, ADD, 32 bits
(P1)SM_REDU R26, R20, VOID, R18, ADD, 32 bits

Where P1=0x91010505 represents an index of a valid lane (for example, the valid lane in 32 lanes), the addresses of the valid lanes of the SM reduction instructions are R10 and R20, the source data are R16 and R18, and the SM reduction instructions both perform a 32-bit addition operation.

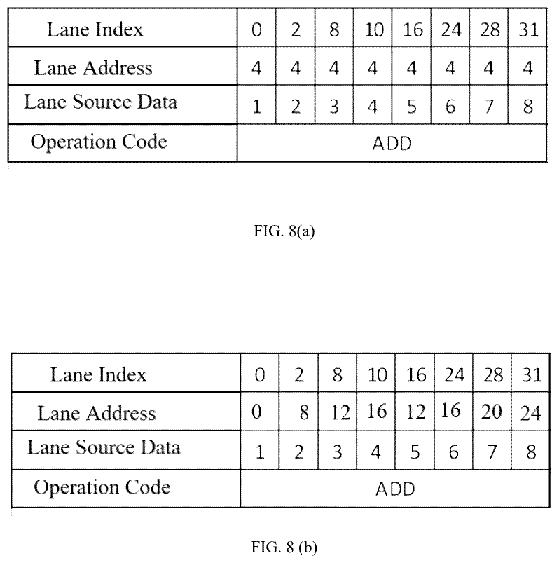

Exemplarily, as shown in FIG. 8 (a), the lane indexes are 0, 2, 8, 10, 16, 24, 28, and 31. The lane addresses are all 4, that is, the addresses of the valid lanes are all the same. The source data of all lanes are 1, 2, 3, 4, 5, 6, 7, and 8. The reduced operation code is ADD. Since the addresses of all valid lanes are the same, the valid lanes can be merged, the number of splits is 1, and only one read operation and one write operation are performed on the SM.

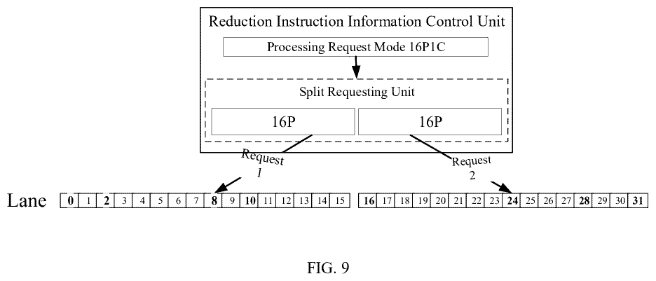

Exemplarily, as shown in FIG. 8 (b), the lane indexes are 0, 2, 8, 10, 16, 24, 28, and 31. The lane addresses are 0, 8, 12, 16, 12, 16, 20 and 24, that is, part of the addresses of the valid lanes are different. The source data of all lanes are 1, 2, 3, 4, 5, 6, 7, and 8. The reduction operation code is ADD. Since the addresses of lanes are not all the same, the splitting mode of the valid lanes may be determined according to whether the addresses of the valid lanes span multiple storage banks. Exemplarily, as shown in FIG. 9, the processing request mode 16P1C may be configured to split the valid lanes, and following two requests are obtained.

Request 1: valid lanes 0, 2, 8, and 10 are included.

Request 2: valid lanes 16, 24, 28, and 31 are included.

In the processing request mode 16P1C, 16 indicates that the processing is performed once per 16 lanes, and 1C indicates a mode that lanes are not integrated.

In this embodiment, through splitting into two requests, only two read operations and two write operations are performed when performing an SM reduction operation.

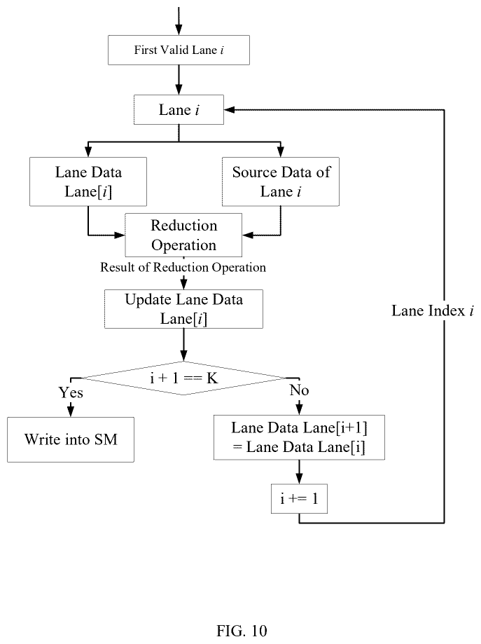

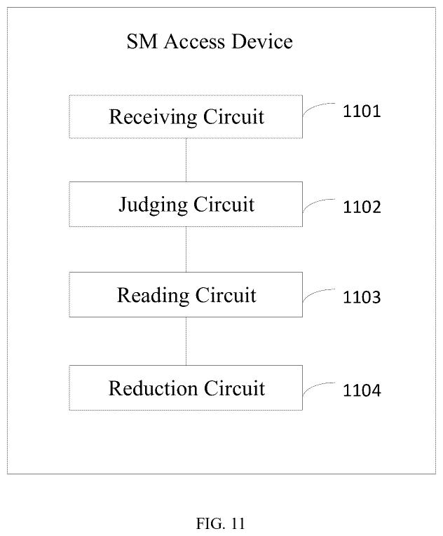

In yet another exemplary embodiment, as shown in FIG. 10, an SM access method is provided and may include the following steps.

In Step S1, let i=0, and obtain the first valid lane Lane i.

In Step S2, point to the Lane i.

In Step S3, obtain lane data of Lane i (denoted as Lane[i]) and source data of the Lane

In Step S4, perform a reduction operation on the lane data and the source data of the Lane i to obtain a result of the reduction operation.

In Step S5, update the lane data Lane[i] of the Lane i according to the result of the reduction operation.

In Step S6, judge whether the value of i+1 is equal to K; if so, write the result of the reduction operation into the SM; if not, set the lane data of Lane i+1 to be Lane[i], and increase i by 1, then return to execute step S2.

Exemplarily, if the identification information on whether to write the result of the reduction operation in the SM reduction instruction is not null, the reduction operation result is written into the GRF.

In this embodiment, by detecting the addresses of the lanes in the workgroup wave, the lanes with the same address are merged, so that only one SM read operation and one SM write operation are required for the same lane address, thereby greatly improving the efficiency of the SM data reduction. In addition, no additional hardware logic is needed in the entire reduction operation, and only the equal-reduction judgment (i.e., an XOR operation for each two addresses) need to be performed on the addresses of the valid lanes of the SM reduction instruction, and the reduction efficiency can be improved without complex hardware logic, thus the cost is low. The method in this embodiment may be applied to SMs with different configurations, may be applied to different reduction operation codes, and supports different data formats.

It should be understood that, although the various steps in the flowcharts involved in the above-mentioned embodiments are displayed in sequence according to the indication of the arrows, these steps are not necessarily executed in sequence according to the order indicated by the arrows. Unless there is a clear explanation in this disclosure, the execution of these steps is not limited according to a strict order restriction, and these steps may be executed in other orders. Moreover, at least part of the steps in the flowcharts involved in the above-mentioned embodiments may include multiple steps or multiple stages, and these steps or stages are not necessarily executed at the same time, but may be executed at different time, and these steps or stages are not necessarily executed in sequence, but may be executed in turn or alternately with other steps or with at least part of the steps or stages in other steps.

Based on the same or similar inventive concept, the embodiments of the present application also provide an SM access device for implementing the SM access method involved above. The solutions implemented for solving the problem provided by the device are similar to the solutions for implementing the above-mentioned method, so the specific limitations in the embodiments of one or more SM access devices provided hereinafter may refer to the limitations of the SM access method above, and will not be described repeatedly herein.

In an exemplary embodiment, as shown in FIG. 11, an SM access device is provided, and the device includes a receiving circuit 1101, a judging circuit 1102, a reading circuit 1103 and a reduction circuit 1104.

The receiving circuit 1101 is configured to receive an SM reduction instruction. Instruction information included in the SM reduction instruction includes address information, an operation code, and source data.

The judging circuit 1102 is configured to perform an equal-reduction judgment on valid lanes according to the address information included in the SM reduction instruction and configured to split the valid lanes according to the result of the equal-reduction judgment. The address information is configured to indicate addresses of the valid lanes.

The reading circuit 1103 is configured to read data from the SM according to the split results of the valid lanes; wherein the split result is associated with the number of times the data need to be read from the SM.

The reduction circuit 1104 is configured to perform a reduction operation according to the data read from the SM, the source data and the operation code included in the SM reduction instruction, and configured to write the result of the reduction operation into the SM.

In an embodiment, the receiving circuit 1101 is specifically configured to:
receive the SM reduction instruction sent by an arithmetic logic unit (ALU), and
store the instruction information included in the SM reduction instruction in an SM buffer.

In an embodiment, the judging circuit 1102 is specifically configured to:
obtain the instruction information from the SM buffer through the reduction instruction information control unit;
traverse and obtain the addresses of the valid lanes, and perform an XOR operation on the addresses of each two valid lanes; if a result of an XOR operation of two valid lanes is not 0, judge that the addresses of the two valid lanes are different; and if the result of the XOR operation of two valid lanes is 0, judge that the addresses of the two valid lanes are the same;
merge the valid lanes with the same address, and retain only valid lanes with different addresses; and
split the valid lanes according to the lane addresses corresponding to the valid lanes with different addresses.

In an embodiment, to traverse and obtain the addresses of the valid lanes, and to perform the XOR operation on the addresses of each two valid lanes include: to perform an XOR operation on the address of the i-th valid lane and the address of the (i+1)-th valid lane, where the value of i is a natural number in a range [0, K−1], and K denotes the total number of the valid lanes.

In an embodiment, to split the valid lanes according to the lane addresses corresponding to the valid lanes with different addresses includes:
if the addresses of the valid lanes are all the same, to determine the number of splits to be 1, and to store the addresses of the valid lanes all in one storage bank;
if an address of a valid lane is different, to judge whether the addresses of the valid lanes span different storage banks, and if the addresses of the valid lanes are stored in one storage bank, to store the addresses of the valid lanes all in this storage bank; and if the addresses of the valid lanes are not all stored in one storage bank, to determine the number of splits according to the number of storage banks spanned by the addresses of the valid lanes.

The configuration of the SM determines the number of storage banks and the width of each storage bank. Each storage bank corresponds to one split unit, and the number of split units corresponds to the number of times data need to be read from the SM.

In an embodiment, the reading circuit 1103 is specifically configured to:
determine the number of times data need to be read from the SM based on the split results of the valid lanes, and determine the address in the SM read request corresponding to each read operation;
read the corresponding data from the SM based on the address in the SM read request

In an embodiment, the reduction circuit 1104 is specifically configured to:
match the data read from the SM to valid lanes indicated by each lane index to obtain data corresponding to each valid lane; and
according to the operation code included in the SM reduction instruction, perform the reduction operation on the data corresponding to each valid lane and the source data corresponding to each valid lane in the SM reduction instruction.

In an embodiment, the instruction information included in the SM reduction instruction further includes the number of the valid lanes, the identification information on whether to write the result of the reduction operation, and the data format supported by the reduction.

In an embodiment, the reduction circuit 1104 of the above device is further configured to, when the identification information on whether to write the result of the reduction operation is not NULL, write the result of the reduction operation into the GRF.

Each module of the above-mentioned SM access device may be implemented in whole or in part by software, hardware, or combinations thereof. The modules may be embedded in or independent of the processor of the computer device in a form of hardware, or may be stored in the memory of the computer device in a form of software to facilitate the processor calling and executing the operations corresponding to each of the above modules.

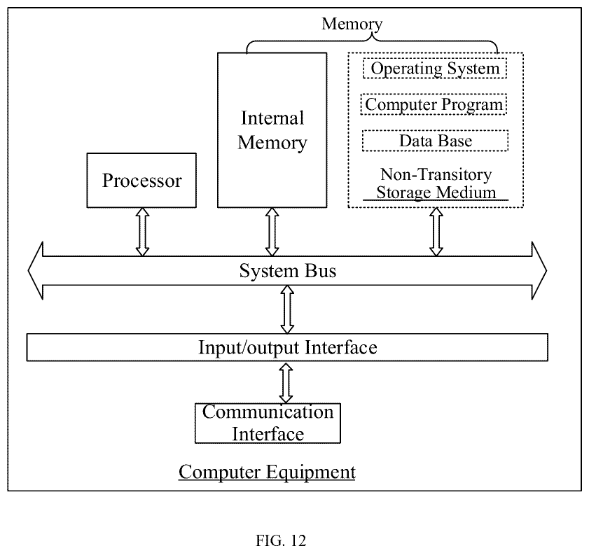

In an exemplary embodiment, a computer equipment is provided, and the computer equipment may be a server, and an internal structure diagram thereof may be as shown in FIG. 12. The computer equipment includes a processor, a memory, an input/output (I/O) interface, and a communication interface. The processor, the memory and the input/output interface are connected via a system bus, and the communication interface is connected to the system bus via the input/output interface. The processor of the computer equipment is configured to provide computing and control capabilities. The memory of the computer equipment includes a non-transitory storage medium and an internal memory. The non-transitory storage medium stores an operating system, a computer program and a database. The internal memory provides an environment for the operation of the operating system and the computer program in the non-transitory storage medium. The database of the computer equipment is configured to store data. The input/output interface of the computer equipment is configured to exchange information between the processor and an external device. The communication interface of the computer equipment is configured to communicate with an external terminal via a network connection. The processor, when executing the computer program, implements the SM access method.

It should be understood by those skilled in the art that the configuration illustrated in FIG. 12, which is only a block diagram of part of the structure related to the solution of the present application, does not constitute a limitation on the computer device to which the solution of the present application is applied. The specific computer device may include more or fewer components than those shown in the figure, or may combine some components, or may have a different arrangement of components.

In an exemplary embodiment, a computer equipment is provided and includes a memory and a processor. A computer program is stored in the memory, and the processor, when executing the computer program, implements the steps in the above-mentioned method embodiments.

In an embodiment, a computer-readable storage medium is provided and has a computer program stored thereon. The computer program, when executed by a processor, implement the steps in the above method embodiments.

In an embodiment, a computer program product is provided, and includes a computer program. The computer program, when executed by a processor, implement the steps in the above method embodiments.

It should be noted that the user information (including but not limited to user device information, user personal information, etc.) and data (including but not limited to data used for analysis, stored data, displayed data, etc.) involved in the present application are information and data authorized by the user or fully authorized by all parties, and the collection, usage and process of relevant data must comply with relevant regulations.

A person of ordinary skill in the art may understand that implementation of all or part of the processes in the methods of the above embodiments may be completed by instructing the relevant hardware through a computer program. The computer program may be stored in a non-transitory computer-readable storage medium. When the computer program is executed, it may include the procedures in the embodiments of the above methods. Any reference to memory, database or other medium used in the embodiments provided in the present application may include at least one of a non-volatile and a volatile memory. The non-volatile memory may include a read-only memory (ROM), a magnetic tape, a floppy disk, a flash memory, an optical memory, a high-density embedded non-volatile memory, a resistive random-access memory (ReRAM), a magnetoresistive random access memory (MRAM), a ferroelectric random-access memory (FRAM), a phase change memory (PCM), or a graphene memory, etc. The volatile memory may include a random-access memory (RAM) or an external cache memory, etc. As an illustration rather than a limitation, the random-access memory may be in various forms, such as a static random-access memory (SRAM) or a dynamic random-access memory (DRAM), etc. The databases involved in the embodiments provided by the present application may include at least one of a relational database and a non-relational database. The non-relational database may include, but is not limited to, a blockchain-based distributed database, etc. The processor involved in the embodiments provided by the present application may be, but is not limited to, a general-purpose processor, a central processor, a graphics processor, a digital signal processor, a programmable logic device, a data processing logic device based on quantum computation, an artificial intelligence (AI) processor, and the like.

The technical features in the above embodiments may be combined arbitrarily. For concise description, not all possible combinations of the technical features in the above embodiments are described. However, provided that they do not conflict with each other, all combinations of the technical features are to be considered to be within the scope described in this specification.

The above-mentioned embodiments only describe several implementations of the present application, and their description is specific and detailed, but should not be understood as a limitation on the patent scope of the present application. It should be noted that, for those skilled in the art, variations and improvements may be further made without departing from the conception of the present application, and these variations and improvements all fall within the protection scope of the present application. Therefore, the protection scope of the present application should be subject to the appended claims.

What is claimed is:

1. A shared memory (SM) access method, comprising:
receiving an SM reduction instruction, instruction information in the SM reduction instruction comprising address information, an operation code, and source data;
performing an equal-reduction judgment on valid lanes according to address information in the SM reduction instruction, and splitting the valid lanes according to a result of the equal-reduction judgment, the address information being configured to indicate addresses of the valid lanes;
reading data from the SM according to split results of the valid lanes, the split result being associated with the number of times the data need to be read from the SM; and
performing a reduction operation according to the data read from the SM, the source data and the operation code in the SM reduction instruction, and writing a result of the reduction operation into the SM.

2. The method according to claim 1, wherein receiving the SM reduction instruction comprises:
receiving the SM reduction instruction sent by an arithmetic logic unit (ALU); and
storing the instruction information in the SM reduction instruction in an SM buffer.

3. The method according to claim 2, wherein performing the equal-reduction judgment on the valid lanes according to the address information in the SM reduction instruction, and splitting the valid lanes according to the result of the equal-reduction judgment, comprise:
obtaining the instruction information from the SM buffer through a reduction instruction information control unit;
traversing and obtaining the addresses of the valid lanes, and performing an XOR operation on addresses of each two valid lanes; if a result of an XOR operation of two valid lanes is not 0, judging that the addresses of the two valid lanes are different; and if the result of the XOR operation of the two valid lanes is 0, judging that the addresses of the two valid lanes are the same;
merging valid lanes with the same address, and retaining valid lanes with different addresses; and
splitting the valid lanes according to the lane addresses corresponding to the valid lanes with different addresses.

4. The method according to claim 3, wherein traversing and obtaining the addresses of the valid lanes, and performing the XOR operation on the addresses of each two valid lanes, comprise:
performing the XOR operation on an address of an i-th valid lane and an address of an (i+1)-th valid lane, wherein a value of i is a natural number in a range [0, K−1], and K denotes a total number of the valid lanes.

5. The method according to claim 4, wherein traversing and obtaining the addresses of the valid lanes, and performing the XOR operation on the addresses of each two valid lanes, further comprise:
when a result of the XOR operation of the address of the i-th valid lane and the address of the (i +1)-th valid lane is 0, outputting a result False;
when the result of the XOR operation of the address of the i-th valid lane and the address of the (i+1)-th valid lane is not 0, judging whether i+1 is equal to K; if so, outputting a result True, and if not, increasing i by 1, and re-judging whether the result of the XOR operation of the address of the i-th valid lane and the address of the (i+1)-th valid lane is 0, until equal-reduction judgments for the valid lanes are all completed.

6. The method according to claim 3, wherein splitting the valid lanes according to the lane addresses corresponding to the valid lanes with different addresses comprises:
if the addresses of the valid lanes are the same, determining the number of splits to be 1, and storing the addresses of the valid lanes in one storage bank; and
if an address of a valid lane is different, judging whether the addresses of the valid lanes span different storage banks; if the addresses of the valid lanes are stored in one storage bank, storing the addresses of the valid lanes in the storage bank; and if the addresses of the valid lanes are not all stored in one storage bank, determining the number of splits according to the number of storage banks spanned by the addresses of the valid lanes;
wherein a configuration of the SM determines the number of storage banks and a width of each storage bank; each storage bank corresponds to one split unit, and the number of split units corresponds to the number of times the data need to be read from the SM.

7. The method according to claim 1, wherein reading the data from the SM according to the split results of the valid lanes comprises:
determining the number of times the data need to be read from the SM based on the split results of the valid lanes, and determining an address in an SM read request corresponding to each read operation; and
reading the data from the SM based on the address in the SM read request.

8. The method according to claim 1, wherein performing the reduction operation according to the data read from the SM, the source data and the operation code in the SM reduction instruction comprises:
matching the data read from the SM to valid lanes indicated by each lane index to obtain data corresponding to each valid lane; and
performing the reduction operation on the data corresponding to each valid lane and the source data corresponding to each valid lane in the SM reduction instruction, according to the operation code in the SM reduction instruction.

9. The method according to claim 1, wherein the instruction information in the SM reduction instruction further comprises the number of the valid lanes, an identification information on whether to write the result of the reduction operation, and a data format supported by the reduction.

10. The method according to claim 9, wherein after writing the result of the reduction operation into the SM, the method further comprises:
when the identification information on whether to write the result of the reduction operation is not NULL, writing the result of the reduction operation into a general register file (GRF).

11. The method according to claim 9, wherein the data format supported by the reduction is 32 bits or 64 bits.

12. The method according to claim 1, wherein the operation code is an addition operation, a minimum operation, or a maximum operation.

13. A shared memory (SM) access device, comprising:
a receiving circuit configured to receive an SM reduction instruction, wherein instruction information in the SM reduction instruction comprises address information, an operation code, and source data;
a judging circuit configured to perform an equal-reduction judgment on valid lanes according to address information in the SM reduction instruction and split the valid lanes according to a result of the equal-reduction judgment, wherein the address information is configured to indicate addresses of the valid lanes;
a reading circuit configured to read data from the SM according to split results of the valid lanes, wherein the split result is associated with the number of times the data need to be read from the SM; and
a reduction circuit configured to perform a reduction operation according to the data read from the SM, the source data and the operation code in the SM reduction instruction and write a result of the reduction operation into the SM.

14. The SM access device according to claim 13, wherein the receiving circuit is configured to:
receive the SM reduction instruction sent by an arithmetic logic unit (ALU); and
store the instruction information in the SM reduction instruction in an SM buffer.

15. The SM access device according to claim 14, wherein the judging circuit is configured to:
obtain the instruction information from the SM buffer through a reduction instruction information control unit;
travers and obtain the addresses of the valid lanes, and perform an XOR operation on addresses of each two valid lanes; if a result of an XOR operation of two valid lanes is not 0, judge that the addresses of the two valid lanes are different; and if the result of the XOR operation of the two valid lanes is 0, judge that the addresses of the two valid lanes are the same;
merge valid lanes with the same address, and retain valid lanes with different addresses; and
split the valid lanes according to the lane addresses corresponding to the valid lanes with different addresses.

16. The SM access device according to claim 13, wherein the reading circuit is configured to:
determine the number of times the data need to be read from the SM based on the split results of the valid lanes, and determine an address in an SM read request corresponding to each read operation; and
read the data from the SM based on the address in the SM read request.

17. The SM access device of claim 13, wherein the reduction circuit is configured to:
match the data read from the SM to valid lanes indicated by each lane index to obtain data corresponding to each valid lane; and
perform the reduction operation on the data corresponding to each valid lane and the source data corresponding to each valid lane in the SM reduction instruction, according to the operation code in the SM reduction instruction.

18. A computer equipment, comprising a memory and a processor, wherein the memory has a computer program stored thereon, and the processor, when executing the computer program, implements steps of the method of claim 1.

19. A non-transitory computer-readable storage medium, having a computer program stored thereon, wherein the computer program, when executed by a processor, causes the processor to implement steps of the method of claim 1.

20. A computer program product, comprising a computer program, wherein the computer program, when executed by a processor, implements steps of the method of claim 1.
